(19) United States
(12) Patent Application Publication
(10) Pub. No.: US 2019/0114001 A1
(43) Pub. Date: Apr. 18, 2019

(54) DISPLAY PANEL FITTED WITH PRESSURE SENSOR

(71) Applicant: SHARP KABUSHIKI KAISHA, Sakai City, Osaka (JP)

(72) Inventors: JEAN MUGIRANEZA, Sakai City (JP); TOMOHIRO KIMURA, Sakai City (JP); TAKAYUKI NISHIYAMA, Sakai City (JP); CHIAKI MINARI, Sakai City (JP)

(21) Appl. No.: 16/090,160

(22) PCT Filed: Mar. 23, 2017
(86) PCT No.: PCT/JP2017/011749

§ 371 Date: Sep. 28, 2018

(30) Foreign Application Priority Data
Mar. 28, 2016 (JP) 2016-064693

(51) Int. Cl. G06F 3/044; G01L 1/14; G01L 5/00; G02F 1/1333; G06F 3/041; G02F 1/1343; G02F 1/1339

(52) U.S. Cl. CPC G06F 3/044; G01L 1/14; G01L 5/00; G02F 1/133514; G06F 3/0412; G02F 1/134309; G02F 1/13394; G02F 1/13338

(57) ABSTRACT

Cost of production of a pressure sensor-equipped display panel is reduced. A pressure sensor-equipped display panel (1) includes a circuit board (2), a counter substrate (3), a liquid crystal layer (4), and a pressure sensor (5) which is configured to detect a pressure applied to the counter substrate (3). The pressure sensor (5) includes (i) driving electrodes (6) provided to the counter substrate (3) and (ii) a sensing electrodes (7) provided to the circuit board (2).

### TECHNICAL FIELD

The present invention relates to a pressure sensor-equipped display panel.

### BACKGROUND ART

There has been known a touch sensor-equipped display panel including a capacitive touch sensor, which allows a user to input information by touching the display panel with his/her finger or the like (Patent Literature 1).

In recent years, attention has been drawn to a pressure sensor which detects a touch made on a display panel. The pressure sensor is capable of distinguishing between a press touch, which is made with a relatively strong pressing force, and a feather touch, which is made with a relatively weak pressing force. This allows a display panel including the pressure sensor to distinguish between (i) a press touch which is made by relatively firmly pressing a screen of the display panel so as to press, for example, an OK button displayed on the screen and (ii) a feather touch which is made by relatively softly and smoothly touching the screen. It is therefore expected that equipping a display panel with such a pressure sensor will improve a misoperation preventing function of the display panel.

### CITATION LIST

### Patent Literature

[Patent Literature 1]

Japanese Patent Application Publication Tokukai No. 2009-244958 (Publication date: Oct. 22, 2009)

[Patent Literature 2]

U.S. Patent Application Publication No. 2014/0085213 (Publication date: Mar. 27, 2014)

### SUMMARY OF INVENTION

### Technical Problem

However, the foregoing pressure sensor is accessorily provided beneath a backlight unit of a display panel. For example, in a case where a display panel includes (i) a circuit board, (ii) a counter substrate, a liquid crystal layer provided between the circuit board and the counter substrate, and (iv) a backlight unit disposed on a side of the counter substrate which side is opposite to the liquid crystal layer, the pressure sensor is externally disposed on a side of the backlight unit which side is opposite to the counter substrate.

Therefore, it is necessary to design the pressure sensor separately from a display panel, and also necessary to individually produce the pressure sensor and the display panel and combine the display panel and the pressure sensor thus individually produced. This unfortunately results in an increase in cost of production of the display panel.

The present invention was made in view of the foregoing issue, and an object of the present invention is to realize a pressure sensor-equipped display panel capable of being produced at lower cost.

### Solution to Problem

In order to attain the above object, a pressure sensor-equipped display panel in accordance with an aspect of the present invention includes: a circuit board; a counter substrate disposed so as to face the circuit board; a liquid crystal layer provided between the circuit board and the counter substrate; and a pressure sensor configured to detect a pressure applied to the counter substrate, the pressure sensor including (i) first electrodes provided to the counter substrate and (ii) second electrodes provided to the circuit board.

### Advantageous Effects of Invention

According to an aspect of the present invention, it is possible to realize a pressure sensor-equipped display panel capable of being produced at lower cost.

### BRIEF DESCRIPTION OF DRAWINGS

FIG. 1 is a cross-sectional view illustrating a configuration of a pressure sensor-equipped display panel in accordance with Embodiment 1.

(a) of FIG. 2 is a plan view illustrating a pattern of driving electrodes provided on a black matrix of the pressure sensor-equipped display panel. (b) of FIG. 2 is a view in which a box A illustrated in (a) of FIG. 2 is enlarged.

FIG. 3 is a plan view illustrating sensing electrodes provided on a TFT substrate of the pressure sensor-equipped display panel.

(a) of FIG. 4 is a plan view illustrating a pattern of the sensing electrodes. (b) of FIG. 4 is a view in which a box B illustrated in (a) of FIG. 4 is enlarged.

FIG. 5 is a block diagram illustrating how a pressure sensor measures a pressure.

(a) of FIG. 6 is a perspective view schematically illustrating how the pressure sensor provided to the pressure sensor-equipped display panel measures a pressure. (b) of FIG. 6 is a perspective view schematically illustrating how a touch sensor provided to the pressure sensor-equipped display panel measures a touch.

FIG. 7 is a timing chart illustrating a relationship among (i) display operation of the pressure sensor-equipped display panel, (ii) operation of the touch sensor, and (iii) operation of the pressure sensor. (a) of FIG. 7 is a timing chart illustrating the relationship in terms of vertical synchronization. (b) of FIG. 7 is a timing chart illustrating the relationship in terms of horizontal synchronization.

FIG. 8 is a cross-sectional view illustrating configuration of a pressure sensor-equipped display panel in accordance with Embodiment 2.

FIG. 9 is a plan view illustrating sensing pad electrodes provided on a TFT substrate of the pressure sensor-equipped display panel.

FIG. 10 is a perspective view schematically illustrating how a pressure sensor provided to the pressure sensor-equipped display panel measures a pressure and how a touch sensor provided to the pressure sensor-equipped display panel measures a touch.

FIG. 11 is a view illustrating configurations of a first part and a second part into which each of sensing electrodes, provided to a pressure sensor-equipped display panel in accordance with Embodiment 3, is divided. (a) of FIG. 11 is a cross-sectional view illustrating the configurations. (b) of FIG. 11 is a plan view illustrating the configurations.

FIG. 12 is a plan view illustrating other configurations of the first part and the second part into which each of the sensing electrodes is divided.

FIG. 13 is a plan view illustrating still other configurations of the first part and the second part into which each of the sensing electrodes is divided.

FIG. 14 is a plan view illustrating still other configurations of the first part and the second part into which each of the sensing electrodes is divided.

FIG. 15 is a cross-sectional view illustrating a configuration of a pressure sensor-equipped display panel in accordance with Embodiment 4.

(a) of FIG. 16 is a plan view illustrating one of driving electrodes provided on a color filter substrate of the pressure sensor-equipped display panel. (b) of FIG. 16 is a plan view illustrating one of sensing electrodes and some of floating electrodes which sensing electrodes and floating electrodes are provided on a TFT substrate of the pressure sensor-equipped display panel.

(a) and (b) of FIG. 17 are each a cross-sectional view illustrating how the pressure sensor-equipped display panel operates.

(a) of FIG. 18 is a cross-sectional view illustrating a configuration of another pressure sensor-equipped display panel in accordance with Embodiment 4. (b) of FIG. 18 is a plan view illustrating sensing electrodes and floating electrodes which sensing electrodes and floating electrodes are provided on a TFT substrate of the another pressure sensor-equipped display panel.

(a) of FIG. 19 is a cross-sectional view illustrating a configuration of a pressure sensor-equipped display panel in accordance with Embodiment 5. (b) of FIG. 19 is a perspective view illustrating the configuration.

(a) of FIG. 20 is a plan view illustrating one of sensing pad electrodes provided on a TFT substrate of the pressure sensor-equipped display panel. (b) of FIG. 20 is a plan view illustrating configurations of driving electrodes and photo spacers which driving electrodes and photo spacers are provided on a color filter substrate of the pressure sensor-equipped display panel.

### DESCRIPTION OF EMBODIMENTS

The following description will discuss embodiments of the present invention in detail.

### Embodiment 1

(Configuration of Pressure Sensor-Equipped Display Panel 1)

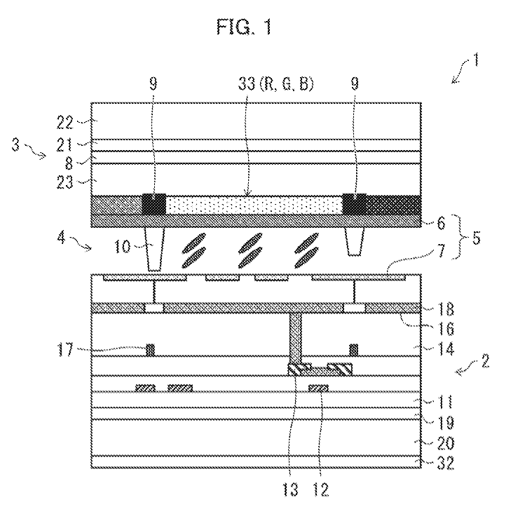

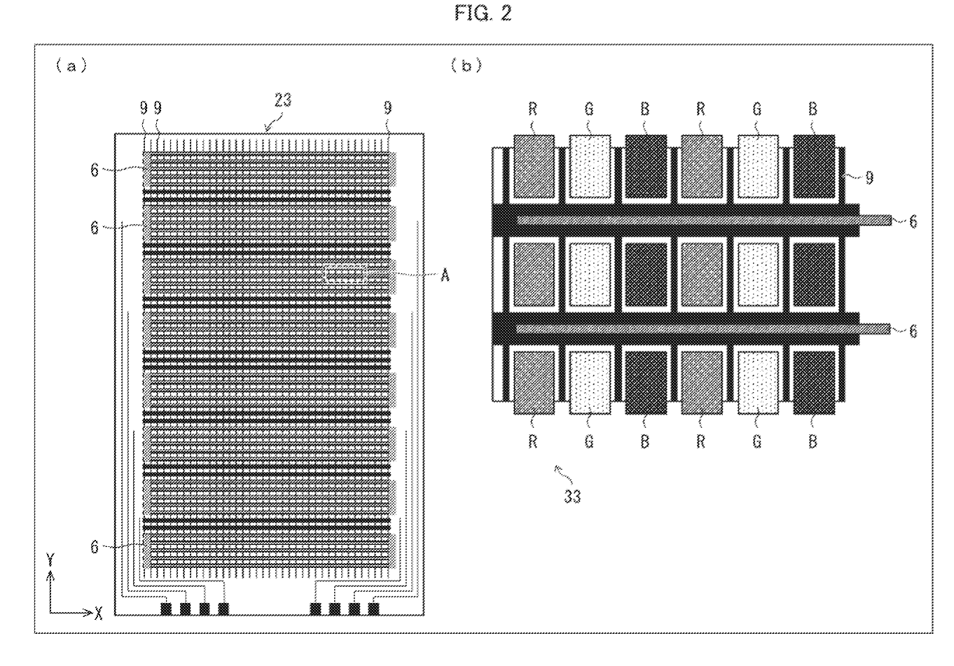

FIG. 1 is a cross-sectional view illustrating configuration of a pressure sensor-equipped display panel 1 in accordance with Embodiment 1. The pressure sensor-equipped display panel 1 includes (i) a circuit board 2, (ii) a counter substrate 3 disposed so as to face the circuit board 2, and (iii) a liquid crystal layer 4 provided between the circuit board 2 and the counter substrate 3.

The circuit board 2 includes a thin film transistor (TFT) substrate 11. The TFT substrate 11 has TFT gate lines 12, TFT source lines 13, a TH layer 14, and a plurality of pixel electrodes 18. The TFT gate lines 12, the TFT source lines 13, the TH layer 14, and the plurality of pixel electrodes 18 are provided on a liquid crystal layer 4 side of the TFT substrate 11. In the TH layer 14, force shield metals 17 are provided. The TFT gate lines 12, the TFT source lines 13, and the TH layer 14 are provided for switching of the plurality of pixel electrodes 18.

A polarizing plate 19, a backlight unit 20, and an EMI layer 32 are provided on a side of the TFT substrate 11 which side is opposite to the liquid crystal layer 4.

The counter substrate 3 includes a color filter (CF) substrate 23. The CF substrate 23 has a color filter 33 and a black matrix 9, which are provided on the liquid crystal layer 4 side of the CF substrate 23.

(Configuration of Pressure Sensor 5)

The pressure sensor-equipped display panel 1 is provided with a pressure sensor 5 which is configured to detect a pressure applied to the counter substrate 3. The pressure sensor 5 includes (i) driving electrodes 6 (first electrodes) provided on the black matrix 9 and (ii) sensing electrodes 7 (second electrodes, common electrode) provided on the liquid crystal layer 4 side of the plurality of pixel electrodes 18. The sensing electrodes 7 serve also as a common electrode which is disposed on the TFT substrate 11 so as to form an electric field by which orientation of liquid crystal molecules contained in the liquid crystal layer 4 is controlled. As such, the liquid crystal layer 4 is provided so as to be sandwiched between the driving electrodes 6 and the sensing electrodes 7.

The sensing electrodes 7 are connected to respective force receiving wires 16 provided between the plurality of pixel electrodes 18 and the TH layer 14. The CF substrate 23 has photo spacers 10 corresponding ones of which are provided on each of the driving electrodes 6 so as to protrude toward the liquid crystal layer 4. This allows a cell thickness of the liquid crystal layer 4 to be maintained. Sensing electrodes 8 for a touch sensor are provided on a side of the CF substrate 23 which side is opposite to the liquid crystal layer 4. On the sensing electrodes 8, a polarizing plate 21 and a cover glass 22 are provided.

A pressure applied to the counter substrate 3 is detected on the basis of changes in capacitances between the driving electrodes 6 and the sensing electrodes 7 which changes are caused by a change in thickness and/or characteristic of the liquid crystal layer 4 due to the pressure.

(a) of FIG. 2 is a plan view illustrating a pattern of the driving electrodes 6 provided on the black matrix 9 of the pressure sensor-equipped display panel 1. (b) of FIG. 2 is a view in which a box A illustrated in (a) of FIG. 2 is enlarged.

The CF substrate 23 has (i) the color filter 33, which is constituted by color filter layers R, G, and B arranged in a cyclic manner, and (ii) the black matrix 9, which is formed in a grid manner so as to partition the color filter layers R, G, and B. The driving electrodes 6, each of which is made of an electrically conductive material, are formed, by patterning, in a dark region of the black matrix 9 so as to extend in an X-axis direction. Such a patterning method minimizes negative optical interference and negative electrical interference each caused by a pressure sensor provided to a display panel.

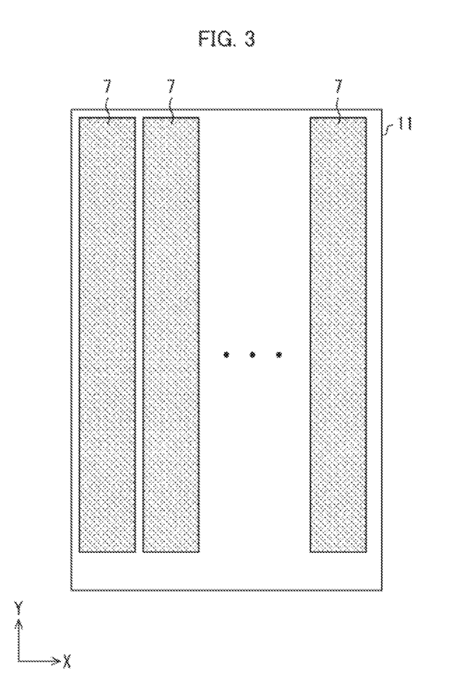

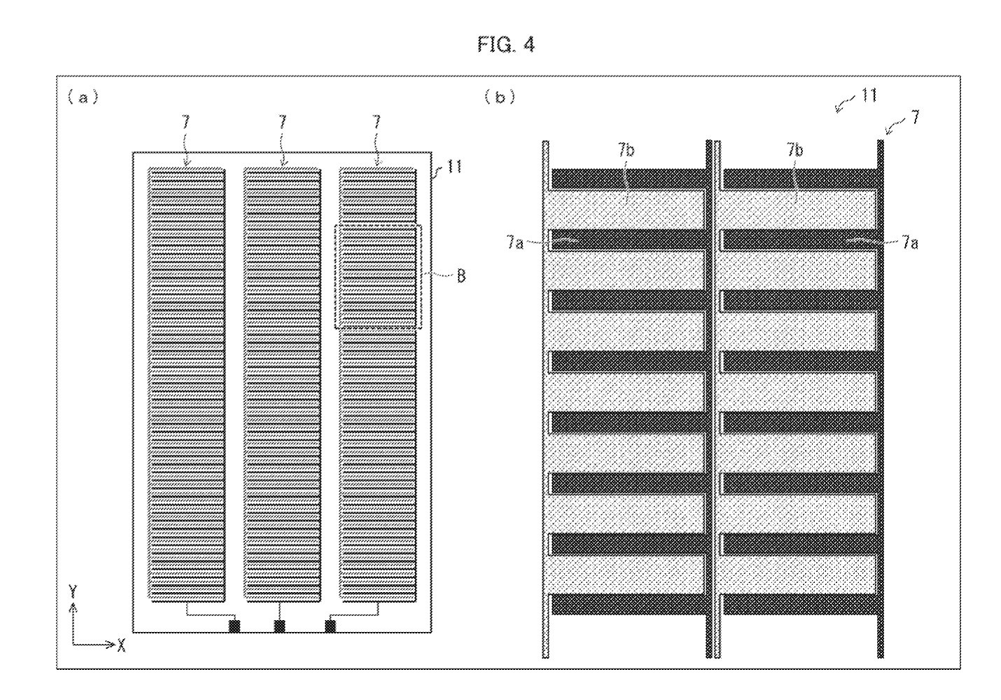

FIG. 3 is a plan view illustrating the sensing electrodes 7 provided to the TFT substrate 11 of the pressure sensor-equipped display panel 1. (a) of FIG. 4 is a plan view illustrating a pattern of the sensing electrodes 7. (b) of FIG. 4 is a view in which a box B illustrated in (a) of FIG. 4 is enlarged.

As illustrated in FIG. 3 and (a) of FIG. 4, the sensing electrodes 7, which serve also as a common electrode of the TFT substrate 11, are formed, by patterning, so as to extend in a Y-axis direction. Each of the sensing electrodes 7 is divided into a first electrode part 7a (first part) and a second electrode part 7b (second part). The first electrode part 7a is configured such that capacitances between the first electrode part 7a and the driving electrodes 6 each increase in response to a change in thickness of the liquid crystal layer 4. The second electrode part 7b is configured such that capacitances between the second electrode part 7b and the driving electrodes 6 each decrease in response to the change in thickness of the liquid crystal layer 4. The first electrode part 7a is provided to the TFT substrate 11 with use of a comb-like pattern so that portions of the first electrode part 7a which portions correspond to teeth of a comb protrude in an X-axis negative direction. The second electrode part 7b is provided to the TFT substrate 11 with use of a comb-like pattern so that portions of the second electrode part 7b which portions correspond to teeth of a comb protrude in an X-axis positive direction and, consequently, the second electrode part 7b engages with the first electrode part 7a. The first electrode part 7a and the second electrode part 7b each thus formed in a comb-like pattern allow an enhancement in pressure detection sensitivity.

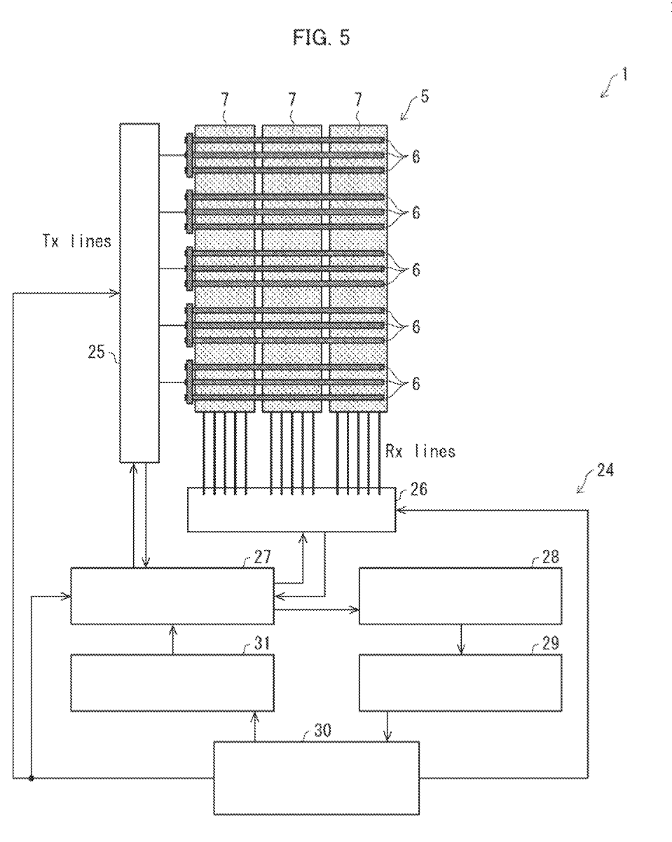

FIG. 5 is a block diagram illustrating how the pressure sensor 5 treasures a pressure. The pressure sensor-equipped display panel 1 includes a controller 24 configured to control the pressure sensor 5. The controller 24 includes a microprocessor 30, a driving pulse generator 31, a switching circuit 27, a sensing circuit 28, and an AD converter 29. The microprocessor 30 controls a sensing signal and thereby allots a sensing time so that a touch and a pressure are detected. The driving pulse generator 31 generates a driving pulse in accordance with an instruction from the microprocessor 30. The switching circuit 27 (i) supplies the driving pulse, generated by the driving pulse generator 31, to a multiplexer 25 connected to the driving electrodes 6 and (ii) receives a sensing signal from a multiplexer 26 connected to the sensing electrodes 7 and supplies the sensing signal thus received to the sensing circuit 28. The sensing circuit 28 amplifies the sensing signal supplied from the switching circuit 27. The AD converter 29 converts, from an analog signal to a digital signal, the sensing signal amplified by the sensing circuit 28 and supplies the sensing signal thus converted to the microprocessor 30.

(Configuration of Touch Sensor)

Referring to FIG. 1 again, the pressure sensor-equipped display panel 1 includes a touch sensor configured to detect a touch made on the counter substrate 3. The touch sensor includes the sensing electrodes 8, which are provided on the side of the CF substrate 23 which side is opposite to the liquid crystal layer 4, so that signals which are based on capacitances between the sensing electrodes 8 and the driving electrodes 6 are read out. The driving electrodes 6 serve also as driving electrodes of the touch sensor.

(Operation of Pressure Sensor-Equipped Display Panel 1)

(a) of FIG. 6 is a perspective view schematically illustrating how the pressure sensor 5 provided to the pressure sensor-equipped display panel 1 measures a pressure. (b) of FIG. 6 is a perspective view schematically illustrating how the touch sensor provided to the pressure sensor-equipped display panel 1 measures a touch.

The pressure sensor 5 shares the sensing circuit 28 (see FIG. 5) and the driving electrodes 6 with the touch sensor. The sensing electrodes 7, for detection of a pressure, and the sensing electrodes 8, for detection of a touch, are successively and alternately switched. During a time period in which a pressure is detected, the sensing electrodes 8 for detection of a touch are grounded so that a noise which is detected while the pressure is detected is minimized. The sensing electrodes 7 for detection of a pressure serve also as a common electrode for liquid crystal display. During a time period in which a touch is detected, the sensing electrodes 7 for detection of a pressure are each set at an electrical potential at which a common electrode for liquid crystal display is set.

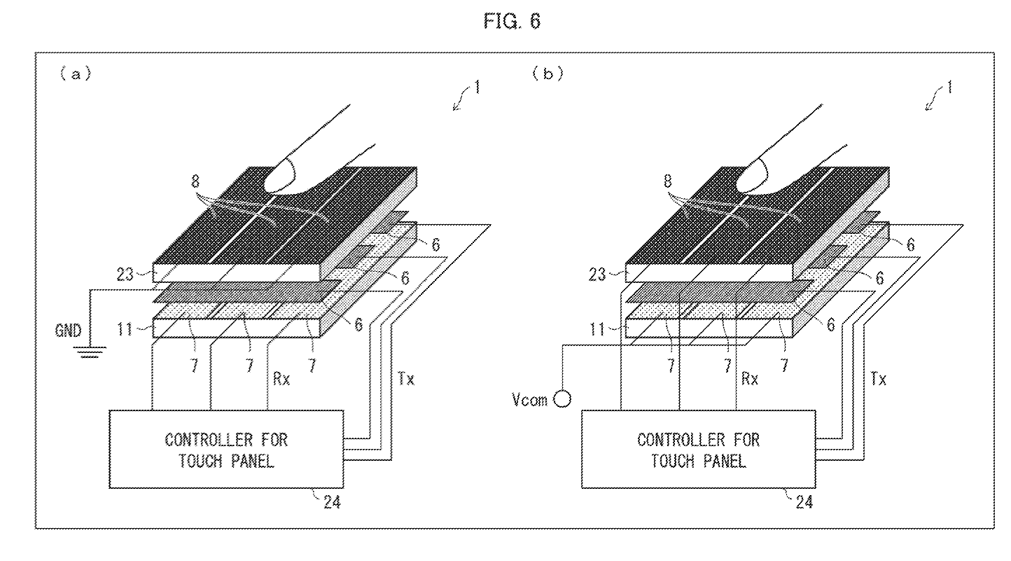

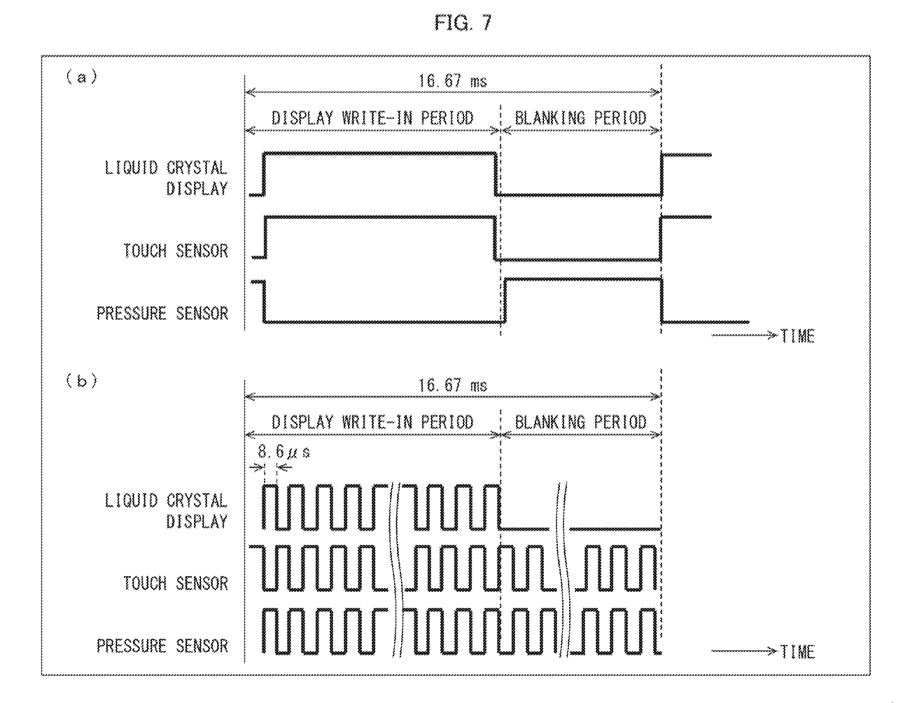

FIG. 7 is a timing chart illustrating a relationship among (i) display operation of the pressure sensor-equipped display panel 1, (ii) operation of the touch sensor, and (iii) operation of the pressure sensor 5. (a) of FIG. 7 is a timing chart illustrating the relationship in terms of vertical synchronization. (b) of FIG. 7 is a timing chart illustrating the relationship in terms of horizontal synchronization.

The pressure sensor 5 operates in synchronization with vertical synchronization with which liquid crystal display is carried out. The touch sensor is configured such that scanning is carried out during a display write-in period in which writing for the liquid crystal display is carried out. In contrast, the pressure sensor 5 is configured such that scanning is carried out during a blanking period in which the writing for the liquid crystal display is not carried out. A screen is refreshed at a rate of 60 Hz so that frames are displayed.

The touch sensor is configured such that, during the display write-in period, scanning is carried out in synchronization with horizontal synchronization with which the liquid crystal display is carried out. In contrast, the pressure sensor 5 is configured such that scanning is carried out during the blanking period so that interference between the operation of the pressure sensor 5 and the liquid crystal display is minimized.

### Embodiment 2

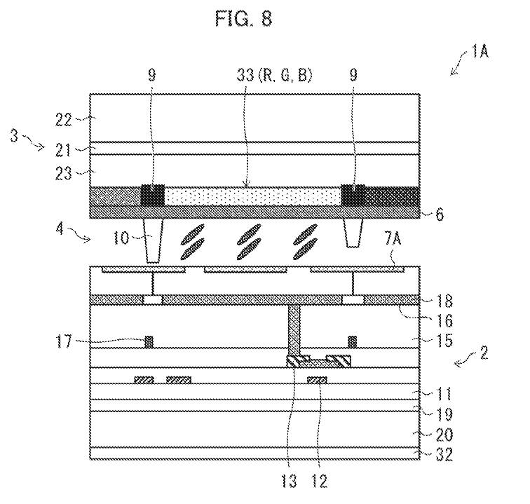

The following description will discuss Embodiment 2 of the present invention with reference to FIGS. 8 through 10. For convenience, members having functions identical to those of the members discussed in Embodiment 1 are given the same reference signs, and the descriptions of such members are omitted.

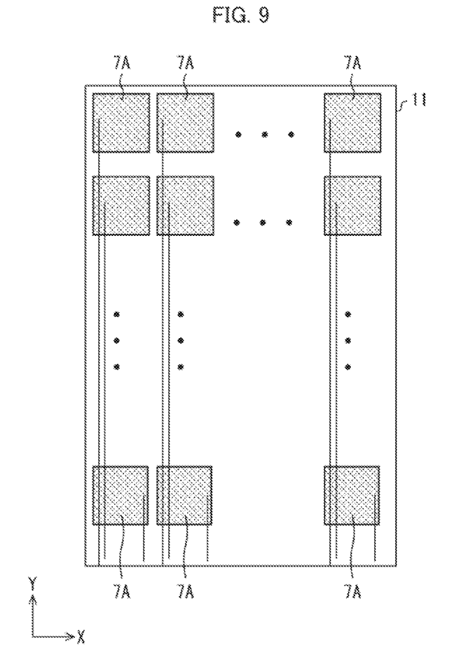

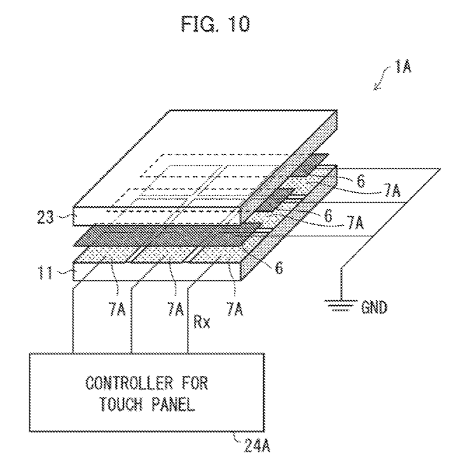

FIG. 8 is a cross-sectional view illustrating a configuration of a pressure sensor-equipped display panel 1A in accordance with Embodiment 2. FIG. 9 is a plan view illustrating sensing pad electrodes 7A provided to a TFT substrate 11 of the pressure sensor-equipped display panel 1A. FIG. 10 is a perspective view schematically illustrating how a pressure sensor provided to the pressure sensor-equipped. display panel 1A measures a pressure and how a touch sensor provided to the pressure sensor-equipped display panel 1A measures a touch.

The touch sensor of the pressure sensor-equipped display panel 1A is of a self-capacitive type, and includes the sensing pad electrodes 7A, each of which has a square shape and which are arranged in a matrix pattern on a liquid crystal layer 4 side of the TFT substrate 11.

The sensing pad electrodes 7A serve also as a common electrode which is disposed on the liquid crystal layer 4 side of the TFT substrate 11 so as to form an electric field by which orientation of liquid crystal molecules contained in a liquid crystal layer 4 is controlled.

The sensing pad electrodes 7A serve also as sensing electrodes corresponding to driving electrodes 6 of the pressure sensor.

The driving electrodes 6, which are provided on the liquid crystal layer 4 side of a CF substrate 23, are (i) grounded during a time period in which the pressure sensor operates and (ii) put in a floating state during a time period in which the touch sensor operates.

### Embodiment 3

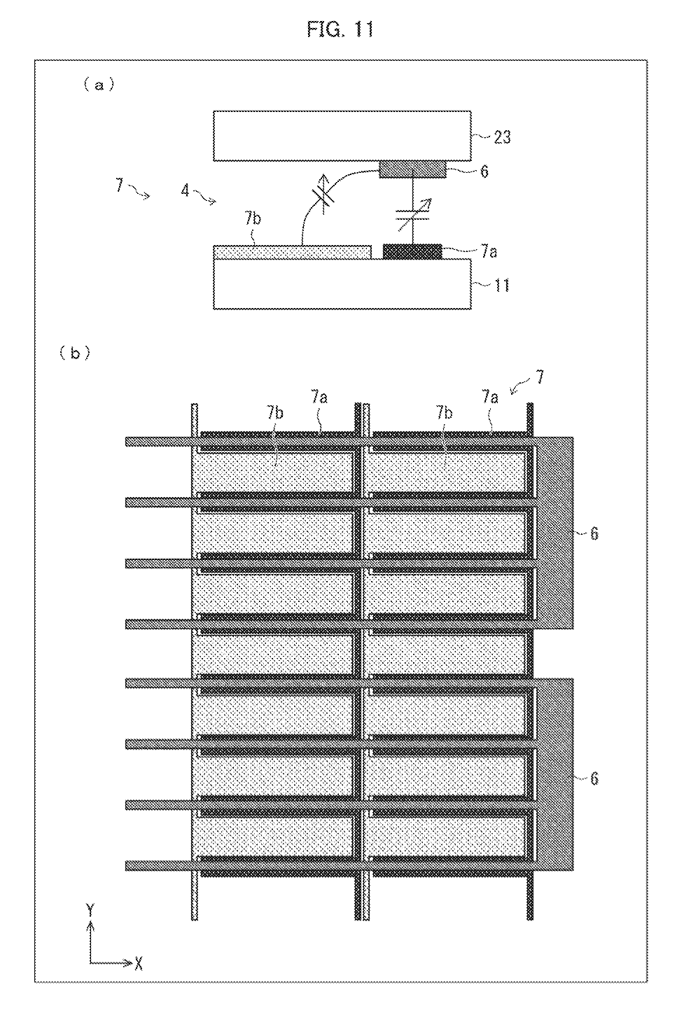

FIG. 11 is a view illustrating configurations of a first electrode part 7a and a second electrode part 7b into which each of sensing electrodes provided to a pressure sensor-equipped display panel in accordance with Embodiment 3, is divided. (a) of FIG. 11 is a cross-sectional view illustrating the configurations. (b) of FIG. 11 is a plan view illustrating the configurations. Components identical to those discussed in Embodiments 1 and 2 are given the same reference signs, and the detailed descriptions of such components are not repeated.

Each of the sensing electrodes 7 provided on a liquid crystal layer 4 side of a TFT substrate 11 is divided into the first electrode part 7a and the second electrode part 7b. The first electrode part 7a is configured such that capacitances between the first electrode part 7a and driving electrodes 6 each increase in response to a change in thickness of a liquid crystal layer 4. The second electrode part 7b is configured such that capacitances between the second electrode part 7b and the driving electrodes 6 each decrease in response to the change in thickness of the liquid crystal layer 4. The first electrode part 7a is disposed immediately below the driving electrodes 6, whereas the second electrode part 7b is disposed diagonally below the driving electrodes 6. As such, the first electrode part 7a is located so as to be closer to the driving electrodes 6 than the second electrode part 7b is.

Each of the driving electrodes 6 is formed on the liquid crystal layer 4 side of a CF substrate 23 with use of a comb-like pattern so that portions of the each of the driving electrodes 6 which portions correspond to teeth of a comb are arranged in a Y-axis direction. The first electrode part 7a is formed on the liquid crystal layer 4 side of the TFT substrate 11 with use of a comb-like pattern corresponding to that used to form the each of the driving electrodes 6. The second electrode part 7b is formed with use of a comb-like pattern so that the second electrode part 7b engages with the first electrode part 7a.

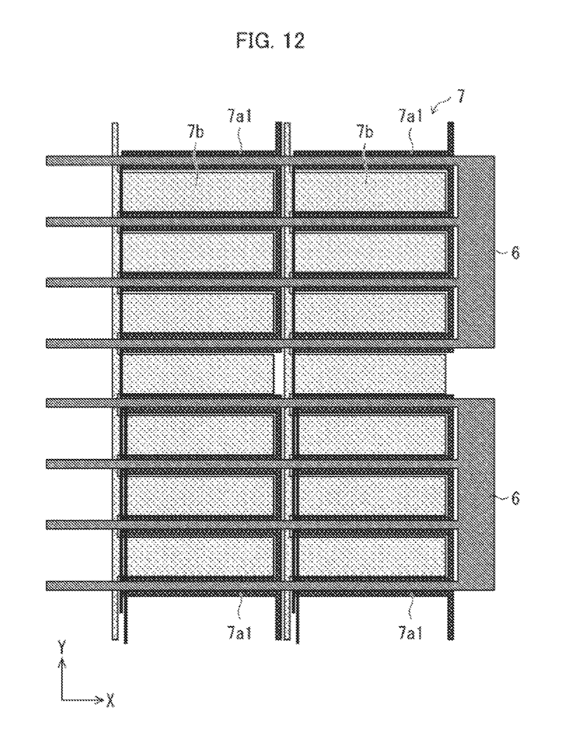

FIG. 12 is a plan view illustrating other configurations of the first electrode part and the second electrode part into which each of the sensing electrodes 7 is divided. (b) of FIG. 11 illustrates an example where first electrode parts 7a are arranged in the Y-axis direction. However, the following configuration can alternatively be employed: first electrode parts 7a1, each having such a comb-like shape that four tooth-like portions protrude in an X-axis negative direction, are disposed in a matrix pattern as illustrated in FIG. 12.

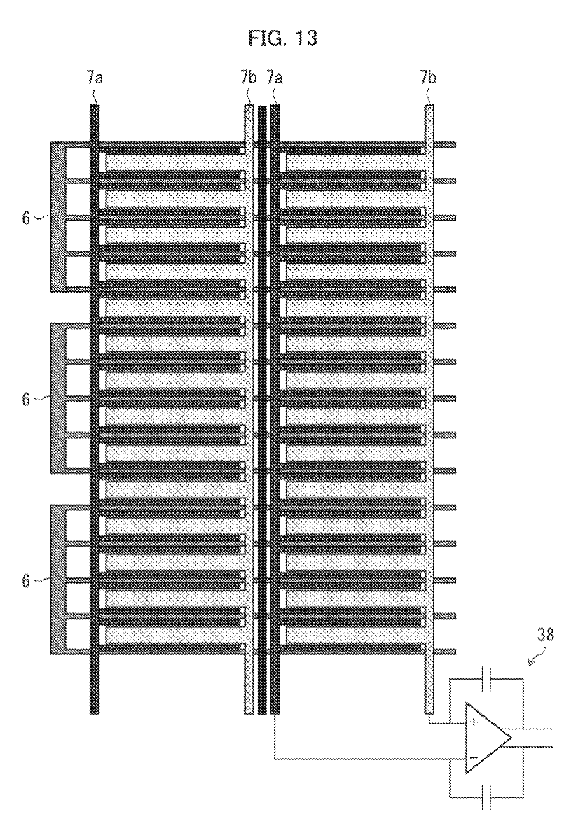

FIG. 13 is a plan view illustrating still other configurations of the first electrode part and the second electrode part into which each of the sensing electrodes 7 is divided. FIG. 11 illustrates an example where (i) the first electrode part 7a is disposed immediately below the driving electrodes 6 and (ii) the second electrode part 7b is disposed diagonally below the driving electrodes 6. However, the present invention is not limited to such an example. Alternatively, the following configuration can be employed:

both the first electrode part 7a and the second electrode part 7b are disposed diagonally below the driving electrodes 6 as illustrated in FIG. 13. In such a case, there is provided an amplifier 38 having (i) a negative input terminal to which the first electrode part 7a is connected and (ii) a positive input terminal to which the second electrode part 7b is connected. The amplifier 38 amplifies a difference between (i) a signal which is based on changes in capacitances between the first electrode part 7a and the driving electrodes 6 and (ii) a signal which is based on changes in capacitances between the second electrode part 7b and the driving electrodes 6.

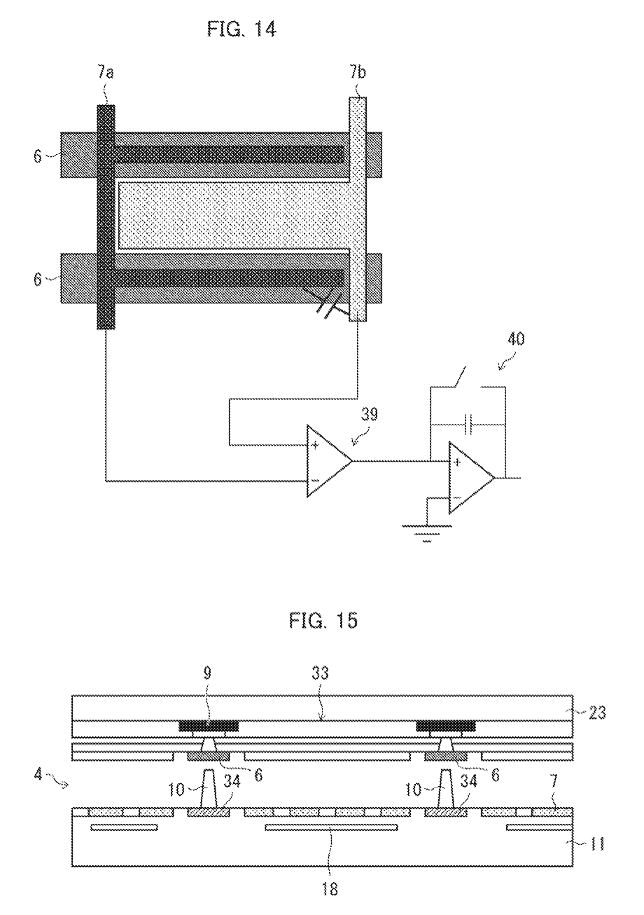

FIG. 14 is a plan view illustrating still other configurations of the first electrode part and the second electrode part into which each of the sensing electrodes 7 is divided.

In this configuration, portions of the first electrode part 7a which portions correspond to teeth of a comb are disposed immediately below the driving electrodes 6, whereas portions of the second electrode part 7b which portions correspond to teeth of a comb are disposed diagonally below the driving electrodes 6. In such a case, there are provided amplifiers 39 and 40. The amplifier 39 has (i) a negative input terminal to which the first electrode part 7a is connected and (ii) a positive input terminal to which the second electrode part 7b is connected. The amplifier 40 has (i) a positive input terminal to which an output is supplied from the amplifier 39 and (ii) a negative input terminal which is grounded. The amplifier 40 has an integral capacitor and a switch, which are provided in parallel to each other between an output of the amplifier 40 and the positive input terminal of the amplifier 40. The amplifier 39 amplifies a signal which is based on a change in capacitance between the first electrode part 7a and the second electrode part 7b (active guard method).

### Embodiment 4

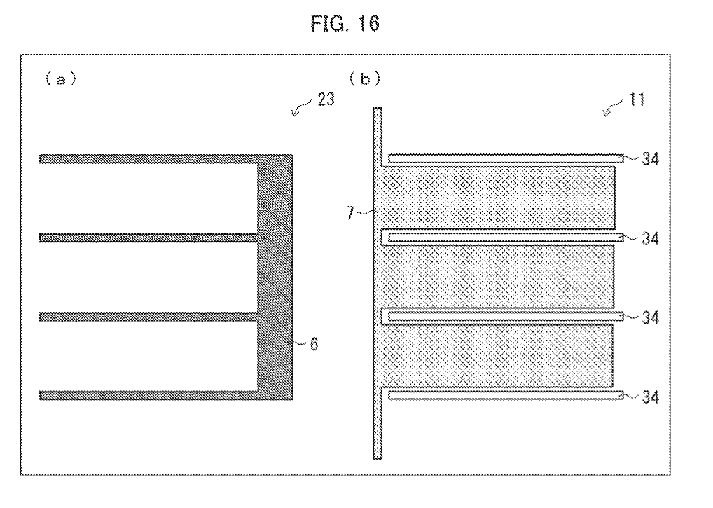

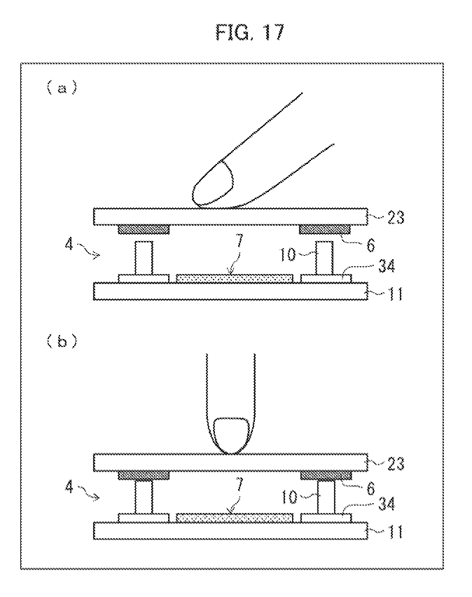

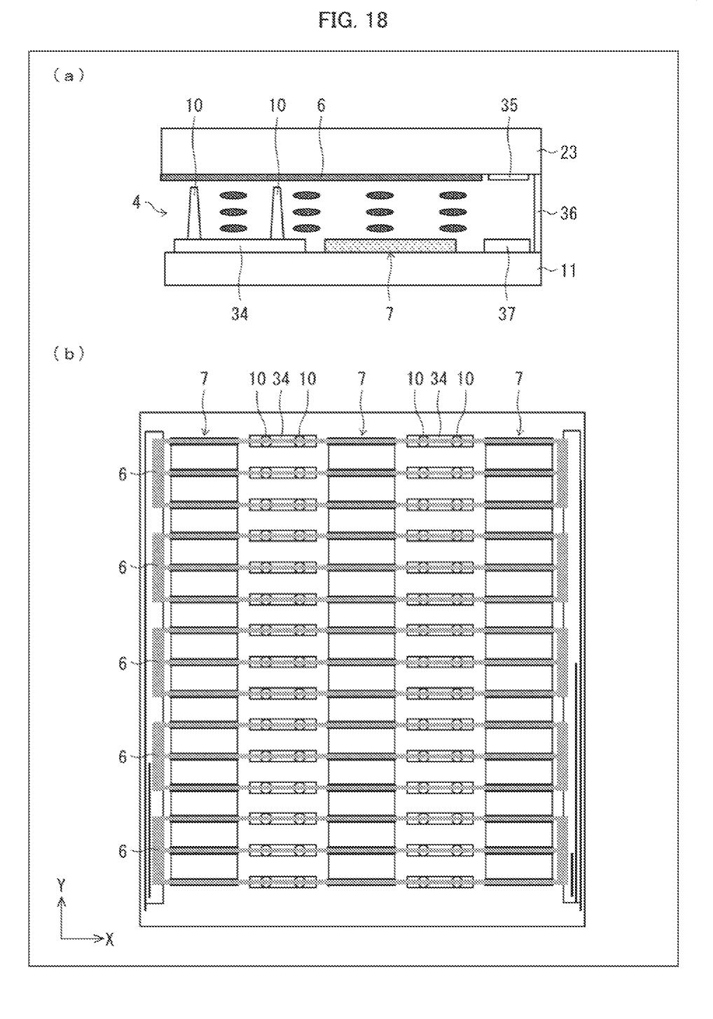

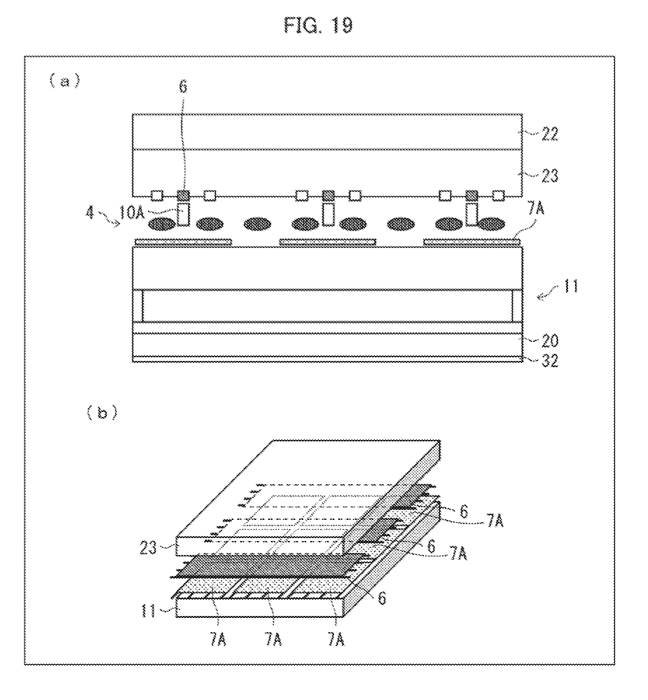

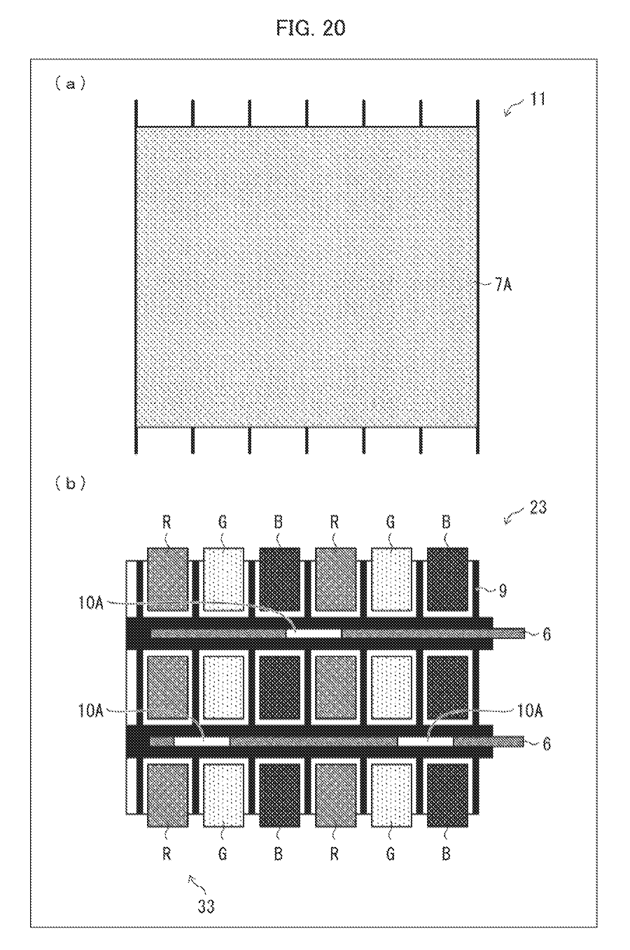

FIG. 15 is a cross-sectional view illustrating a configuration of a pressure sensor-equipped display panel in accordance with Embodiment 4. (a) of FIG. 16 is a plan view illustrating one of driving electrodes 6 provided to a CF substrate 23 of the pressure sensor-equipped display panel. (b) of FIG. 16 is a plan view illustrating one of sensing electrodes 7 and some of floating electrodes 34 which sensing electrodes 7 and floating electrodes 34 are provided on a TFT substrate 11 of the pressure sensor-equipped display panel. Components identical to those discussed in Embodiments 1, 2, and 3 are given the same reference signs, and the detailed descriptions of such components are not repeated.

The floating electrodes 34 are formed on the TFT substrate 11. Each of the sensing electrodes 7 is formed in a comb-like shape so that each of portions of the each of the sensing electrodes 7 which portions correspond to teeth of a comb is sandwiched between adjacent ones of the floating electrodes 34. On the floating electrodes 34, there are provided photo spacers 10 (electrically conductive poles) corresponding to the driving electrodes 6. The floating electrodes 34 are located so as to correspond to the driving electrodes 6.

(a) and (b) of FIG. 17 are each a cross-sectional view illustrating how the pressure sensor-equipped display panel operates. In a case where a pressure is applied to the CF substrate 23 by a touch with a finger or the like, the driving electrodes 6 are connected to the photo spacers 10 and thereby caused to be electrically continuous with the floating electrodes 34. This causes (i) a decrease in stray capacitance related to the driving electrodes 6 and (ii) an increase in mutual capacitance between the driving electrodes 6 and the sensing electrodes 7.

(a) of FIG. 18 is a cross-sectional view illustrating a configuration of another pressure sensor-equipped display panel in accordance with Embodiment 4. (b) of FIG. 18 is a plan view illustrating sensing electrodes 7 and floating electrodes 34 which sensing electrodes 7 and floating electrodes 34 are provided on a TFT substrate 11 of the another pressure sensor-equipped display panel.

As illustrated in FIG. 18, the sensing electrodes 7 and rows of the floating electrodes 34 can be alternately disposed in an X-axis direction. The driving electrodes 6 are located so as to correspond to the sensing electrodes 7 and the rows of the floating electrodes 34, which sensing electrodes 7 and rows of the floating electrodes 34 are alternately disposed in the X-axis direction. Wires 35 corresponding to the respective driving electrodes 6 are provided on a liquid crystal layer 4 side of the CF substrate 23. Gate driver monolithic circuits (GDM) 37 are provided on the liquid crystal layer 4 side of the TFT substrate 11. Between the TFT substrate 11 and the CF substrate 23, there is provided a sealing member 36.

In a case where (i) the floating electrodes 34 are provided as described above and (ii) a pressure is applied to the CF substrate 23 by a touch with a finger or the like, the driving electrodes 6 are connected to the photo spacers 10 and thereby caused to be electrically continuous with the floating electrodes 34. This causes the driving electrodes 6 to extend their substantial areas to the floating electrodes 34, and thereby enhances the strength of pressure detection signals which are read out from the sensing electrodes 7 on the basis of capacitances between the sensing electrodes 7 and the driving electrodes 6. The configuration is therefore expected to enhance pressure detection efficiency.

### Embodiment 5

(a) of FIG. 19 is a cross-sectional view illustrating a configuration of a pressure sensor-equipped display panel in accordance with Embodiment 5. (b) of FIG. 19 is a perspective view illustrating the configuration. (a) of FIG. 20 is a plan view illustrating one of sensing pad electrodes 7A provided on a TFT substrate 11 of the pressure sensor-equipped display panel. (b) of FIG. 20 is a plan view illustrating configurations of driving electrodes 6 and photo spacers 10A which driving electrodes 6 and photo spacers 10A are provided on a CF substrate 23 of the pressure sensor-equipped display panel. Components identical to those discussed in Embodiments 1, 2, 3, and 4 are given the same reference signs, and the detailed descriptions of such components are not repeated.

The photo spacers 10A disposed in a liquid crystal layer 4 are each made of a material which is reactive to a pressure. Examples of such a material include polydimethylsiloxane (PDMS), polyvinylidene fluoride (PVDF), a piezo-electric polymer, and a polymer which is reactive to a pressure. The PDMS deforms in reaction to a pressure. The PVDF changes in resistance and/or electrical characteristic in reaction to a pressure. The photo spacers 10A are provided on a black matrix 9 as with the driving electrodes 6. The sensing pad electrodes 7A are disposed in a matrix pattern on a liquid crystal layer 4 side of the TFT substrate 11.

[Recap]

A pressure sensor-equipped display panel 1, 1A in accordance with a first aspect of the present invention includes: a circuit board 2; a counter substrate 3 disposed so as to face the circuit board 2; a liquid crystal layer 4 provided between the circuit board 2 and the counter substrate 3; and a pressure sensor 5 configured to detect a pressure applied to the counter substrate 3, the pressure sensor 5 including (i) first electrodes (driving electrodes 6) provided to the counter substrate 3 and (ii) second electrodes (sensing electrodes 7) provided to the circuit board 2.

According to the configuration, (i) the first electrodes of the pressure sensor are provided to the counter substrate and (ii) the second electrodes of the pressure sensor are provided to the circuit board. The pressure sensor is thus incorporated in the display panel. This eliminates the need for designing the pressure sensor separately from the display panel and also eliminates the need for individually producing the pressure sensor and the display panel and combining the display panel and the pressure sensor thus individually produced. It is therefore possible to reduce the cost of production of the pressure sensor-equipped display panel.

The pressure sensor-equipped display panel 1, 1A in accordance with a second aspect of the present invention can be configured to further include, in the first aspect of the present invention, a color filter 33 constituted by color filter layers R, G, and B which are arranged in a cyclic manner; and a black matrix 9 formed in a grid manner so as to partition the color filter layers R, G, and B, the color filter and the black matrix being disposed on a liquid crystal layer 4 side of the counter substrate 3, the first electrodes (driving electrodes 6) being provided on the black matrix 9.

The configuration allows the black matrix for partitioning the color filter layers to serve also as electrodes of the pressure sensor.

The pressure sensor-equipped display panel 1, 1A in accordance with a third aspect of the present invention can be configured such that, in the first or second aspect of the present invention, the second electrodes (sensing electrodes 7) serve also as a common electrode which is provided to the circuit board 2 so as to form an electric field by which orientation of liquid crystal molecules contained in the liquid crystal layer 4 is controlled.

According to the configuration, the pressure sensor is caused to operate during a blanking period of liquid crystal display. This allows the electrodes of the pressure sensor to serve also as a common electrode for forming an electric field by which orientation of liquid crystal molecules contained in the liquid crystal layer is controlled.

The pressure sensor-equipped display panel 1 in accordance with a fourth aspect of the present invention can be configured such that, in the first aspect of the present invention, each of the second electrodes (sensing electrodes 7) is divided into (i) a first part (first electrode part 7a) which is configured such that capacitances between the first part (first electrode part 7a) and the first electrodes (driving electrodes 6) each increase in response to a change in distance between the circuit board 2 and the counter substrate 3 and (ii) a second part (second electrode part 7b) which is configured such that capacitances between the second part (second electrode part 7b) and the first electrodes (driving electrodes 6) each decrease in response to the change in distance between the circuit board 2 and the counter substrate 3.

According to the configuration, it is possible to determine whether a detection target by which the pressure has been applied is an electrically conductive object or an electrically non-conductive object, by reading out (i) a signal which is based on the capacitances related to the first part and (ii) a signal which is based on the capacitances related to the second part.

The pressure sensor-equipped display panel 1 in accordance with a fifth aspect of the present invention can be configured such that, in the fourth aspect of the present invention, the first part (first electrode part 7a) is located so as to be closer to the first electrodes (driving electrodes 6) than the second part (second electrode part 7b) is.

According to the configuration, in a case where an electrically conductive object is brought close to the pressure sensor-equipped display panel, both (i) the capacitances between the first part and the first electrodes and (ii) the capacitances between the second part and the first electrodes decrease. In contrast, in a case where an electrically non-conductive object is brought close to the pressure sensor-equipped display panel, the capacitances between the first part and the first electrodes decrease, but the capacitances between the second part and the first electrodes increase. It is therefore possible to determine whether a detection target by which the pressure has been applied is an electrically conductive object or an electrically non-conductive object.

The pressure sensor-equipped display panel 1 in accordance with a sixth aspect of the present invention can be configured such that, in the fourth aspect of the present invention, in the counter substrate 3, each of the first electrodes (driving electrodes 6) is formed with use of a comb-like pattern; and in the circuit board 2, the first part (first electrode part 7a) is formed with use of a comb-like pattern corresponding to the comb-like pattern used to form the each of the first electrodes (driving electrodes 6).

The configuration allows the first part to be disposed immediately below the first electrodes. As such, the first part is located so as to be closer to the first electrodes than the second part is.

The pressure sensor-equipped display panel 1 in accordance with a seventh aspect of the present invention can be configured to further include, in the first aspect of the present invention, floating electrodes 34 provided to the circuit board 2; and electrically conductive poles (photo spacers 10) which are disposed on the floating electrodes 34 and which correspond to the first electrodes (driving electrodes 6), the floating electrodes 34 being located so as to correspond to the first electrodes (driving electrodes 6), in a case where a pressure is applied to the counter substrate 3, the first electrodes (driving electrodes 6) being connected to the electrically conductive poles (photo spacers 10) and thereby caused to be electrically continuous with the floating electrodes 34.

According to the configuration, in a case where the first electrodes are connected to the electrically conductive poles and thereby caused to be electrically continuous with the floating electrodes, the stray capacitance related to the first electrodes decreases and. the mutual capacitance between the first electrodes and the second electrodes increases.

The pressure sensor-equipped display panel 1 in accordance with an eighth aspect of the present invention can be configured such that, in the seventh aspect of the present invention, the first electrodes (driving electrodes 6) are located so as to face the floating electrodes 34 and the second electrodes (sensing electrodes 7).

The configuration makes it possible to alternately dispose the sensing electrodes 7 and the floating electrodes 34 in the X-axis direction.

The pressure sensor-equipped display panel 1A in accordance with a ninth aspect of the present invention can be configured to further include, in the first aspect of the present invention, photo spacers 10A which are disposed in the liquid crystal layer 4 and each of which is made of a material that is reactive to the pressure.

The configuration allows an enhancement in sensitivity of the pressure sensor.

The pressure sensor-equipped display panel 1, 1A in accordance with a tenth aspect of the present invention can be configured to further include, in the first aspect of the present invention, a touch sensor configured to detect a touch made on the counter substrate 3.

According to the configuration, by causing (i) the pressure sensor to detect a press touch, which is made by relatively firmly pressing a screen so as to press an OK button displayed on the screen, and (ii) the touch sensor to detect a feather touch, which is made by relatively softly and smoothly touching the screen, it is possible for the display panel to distinguish between the press touch and the feather touch.

The pressure sensor-equipped display panel 1 inn accordance with an eleventh aspect of the present invention can be configured such that, in the tenth aspect of the present invention, the first electrodes (driving electrodes 6) are disposed on a liquid crystal layer 4 side of the counter substrate 3; the touch sensor includes sensing electrodes 8, provided on a side of the counter substrate 3 which side is opposite to the liquid crystal layer 4, so that signals which are based on capacitances between the sensing electrodes 8 and the first electrodes (driving electrodes 6) are read out; and the first electrodes (driving electrodes 6) serve also as driving electrodes of the touch sensor.

The configuration allows the driving electrodes of the pressure sensor to serve also as driving electrodes of the touch sensor.

The pressure sensor-equipped display panel 1A in accordance with a twelfth aspect of the present invention can be configured such that, in the tenth aspect of the present invention, the touch sensor is of a self-capacitive type, and includes a plurality of sensing pad electrodes 7A provided to the circuit board 2.

The configuration makes it possible to incorporate a self-capacitive touch sensor into the display panel.

The pressure sensor-equipped display panel 1A in accordance with a thirteenth aspect of the present invention can be configured such that, in the twelfth aspect of the present invention, the plurality of sensing pad electrodes 7A serve also as the second electrodes(sensing electrodes 7).

The configuration allows the sensing pad electrodes of the self-capacitive touch sensor to serve also as the sensing electrodes of the pressure sensor.

The pressure sensor-equipped display panel 1A in accordance with a fourteenth aspect of the present invention can be configured such that, in the twelfth aspect of the present invention, the plurality of sensing pad electrodes 7A serve also as a common electrode which is provided to the circuit board 2 so as to form an electric field by which orientation of liquid crystal molecules contained in the liquid crystal layer 4 is controlled.

The configuration allows the sensing pad electrodes of the self-capacitive touch sensor to serve also as a common electrode for forming electric field by which orientation of liquid crystal molecules contained in the liquid crystal layer is controlled.

The present invention is not limited to the embodiments, but can be altered by a skilled person in the art within the scope of the claims. The present invention also encompasses, in its technical scope, any embodiment derived by combining technical means disclosed in differing embodiments. Further, it is possible to form a new technical feature by combining the technical means disclosed in the respective embodiments.

### REFERENCE SIGNS LIST

1: Pressure sensor-equipped display

2: Circuit board

3: Counter substrate

4: Liquid crystal layer

5: Pressure sensor

6: Driving electrode (first electrode, second electrode)

7: Sensing electrode (first electrode, second electrode)

7A: Sensing pad electrode

7a: First electrode part (first part)

7b: Second electrode part (second part)

8: Sensing electrode

9: Black matrix

10: Photo spacer (electrically conductive pole)

10A: Photo spacer

33: Color filter

34: Floating electrode

R, G, B: Color filter layer

1. A pressure sensor-equipped display panel, comprising:
a circuit board;
a counter substrate disposed so as to face the circuit board;
a liquid crystal layer provided between the circuit board and the counter substrate; and
a pressure sensor configured to detect a pressure applied to the counter substrate,
the pressure sensor including (i) first electrodes provided to the counter substrate and (ii) second electrodes provided to the circuit board.

2. The pressure sensor-equipped display panel as set forth in claim 1, further comprising:
a color filter constituted by color filter layers which are arranged in a cyclic manner; and
a black matrix formed in a grid manner so as to partition the color filter layers,
the color filter and the black matrix being disposed on a liquid crystal layer side of the counter substrate,
the first electrodes being provided on the black matrix.

3. The pressure sensor-equipped display panel as set forth in claim 1, wherein the second electrodes serve also as a common electrode which is provided to the circuit board so as to form an electric field by which orientation of liquid crystal molecules contained in the liquid crystal layer is controlled.

4. The pressure sensor-equipped display panel as set forth in claim 1, wherein each of the second electrodes is divided into (i) a first part which is configured such that capacitances between the first part and the first electrodes each increase in response to a change in distance between the circuit board and the counter substrate and (ii) a second part which is configured such that capacitances between the second part and the first electrodes each decrease in response to the change in distance between the circuit hoard and the counter substrate.

5. The pressure sensor-equipped display panel as set forth in claim 4, wherein the first part is located so as to be closer to the first electrodes than the second part is.

6. The pressure sensor-equipped display panel as set forth in claim 4, wherein:
in the counter substrate, each of the first electrodes is formed with use of a comb-like pattern; and
in the circuit board, the first part is formed with use of a comb-like pattern corresponding to the comb-like pattern used to form the each of the first electrodes.

7. The pressure sensor-equipped display panel as set forth in claim 1, further comprising:
floating electrodes provided to the circuit board; and
electrically conductive poles which are disposed on the floating electrodes and which correspond to the first electrodes,
the floating electrodes being located so as to correspond to the first electrodes,
in a case where a pressure is applied to the counter substrate, the first electrodes being connected to the electrically conductive poles and thereby caused to he electrically continuous with the floating electrodes.

8. The pressure sensor-equipped display panel as set forth in claim 7, wherein the first electrodes are located so as to face the floating electrodes and the second electrodes.

9. The pressure sensor-equipped display panel as set forth in claim 1, further comprising:
photo spacers which are disposed in the liquid crystal layer and each of which is made of a material that is reactive to the pressure.

10. The pressure sensor-equipped display panel as set forth in claim 1, further comprising:
a touch sensor configured to detect a touch made on the counter substrate.

11. The pressure sensor-equipped display panel as set forth in claim 10, wherein:
the first electrodes are disposed on a liquid crystal layer side of the counter substrate;
the touch sensor includes sensing electrodes, provided on a side of the counter substrate which side is opposite to the liquid crystal layer, so that signals which are based on capacitances between the sensing electrodes and the first electrodes are read out; and
the first electrodes serve also as driving electrodes of the touch sensor.

12. The pressure sensor-equipped display panel as set forth in claim 10, wherein the touch sensor is of a self-capacitive type, and includes a plurality of sensing pad electrodes provided to the circuit board.

13. The pressure sensor-equipped display panel as set forth in claim 12, wherein the plurality of sensing pad electrodes serve also as the second electrodes.

14. The pressure sensor-equipped display panel as set forth in claim 12, wherein the plurality of sensing pad electrodes serve also as a common electrode which is provided to the circuit board so as to form an electric field by which orientation of liquid crystal molecules contained in the liquid crystal layer is controlled.
